(19) United States
(12) Patent Application Publication
(10) Pub. No.: US 2026/0237849 A1
(43) Pub. Date: Aug. 13, 2026

(54) SPONTANEOUS SOLID-PHASE PRELITHIATION OF SILICON ANODE ELECTRODE FOR LITHIUM-ION BATTERIES

(71) Applicant: GM GLOBAL TECHNOLOGY OPERATIONS LLC, Detroit, MI (US)

(72) Inventors: Zhe LI, Shanghai (CN); Haijing LIU, Shanghai (CN); Qili SU, Shanghai (CN); Hui YAN, Changzhou (CN); Jun LUO, Changzhou (CN)

(21) Appl. No.: 19/414,514

(22) Filed: Dec. 10, 2025

(30) Foreign Application Priority Data
Feb. 7, 2025 (CN) 2025101380932

(51) Int. Cl. H01M 50/46; H01M 4/02; H01M 4/36; H01M 4/38; H01M 4/485; H01M 4/58; H01M 10/0562

(52) U.S. Cl. CPC H01M 50/46; H01M 4/366; H01M 4/386; H01M 4/485; H01M 4/5825; H01M 10/0562; H01M 2004/027; H01M 2004/028

(57) ABSTRACT

A battery cell includes C cathode electrodes including a cathode active material layer arranged on one or both sides of a cathode current collector, A anode electrodes, and S separators arranged between adjacent ones of the C cathode electrodes and the A anode electrodes, where C, S and A are integers greater than one. Each of the A anode electrodes includes an anode current collector, a lithium silicide layer arranged on the anode current collector, and an artificial solid electrolyte interface arranged in first regions on one side of the lithium silicide layer and not in second regions on the one side of the lithium silicide layer. The artificial solid electrolyte interface includes one or more materials selected from a group consisting of lithium carbonate (Li₂CO₃), lithium nitride (Li₃N), lithium oxide (Li₂O), lithium phosphide (Li₃P), lithium phosphate (Li₃PO₄), and combinations thereof.

### CROSS-REFERENCE TO RELATED APPLICATIONS

This application claims the benefit of Chinese Patent Application No. 202510138093.2, filed on Feb. 7, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a prelithiated silicon anode electrode for lithium-ion battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes including a cathode active material layer arranged on one or both sides of a cathode current collector, A anode electrodes, and S separators arranged between adjacent ones of the C cathode electrodes and the A anode electrodes, where C, S and A are integers greater than one. Each of the A anode electrodes includes an anode current collector, a lithium silicide layer arranged on the anode current collector, and an artificial solid electrolyte interface arranged in first regions on one side of the lithium silicide layer and not in second regions on the one side of the lithium silicide layer.

In other features, the artificial solid electrolyte interface includes one or more materials selected from a group consisting of lithium carbonate (Li₂CO₃), lithium nitride (Li₃N), lithium oxide (Li₂O), lithium phosphide (Li₃P), lithium phosphate (Li₃PO₄), and combinations thereof.

In other features, the first regions comprise 50% to 95% of the one side of the lithium silicide layer. The artificial solid electrolyte interface includes lithium carbonate (Li₂CO₃), lithium nitride (Li₃N), lithium oxide (Li₂O), lithium phosphide (Li₃P), lithium phosphate (Li₃PO₄). The lithium silicide layer comprises LixSi where an x is in a range from 0.01 to 3.0.

In other features, the cathode active material layer includes a cathode active material selected from a group consisting of a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by at least one of LiMeSO₄F or LiMePO₄F, sulfur, lithium sulfide, and combinations thereof, where Me is a transition metal. The cathode active material includes a coating layer including LiNbO₃ and/or Li₃PO₄.

In other features, the cathode active material layer further includes a solid electrolyte selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof. The cathode active material layer further includes a binder selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-cohexafluoropropylene) (PVDF-HFP), polyethylene oxide (PEO), polyacrylonitrile (PAN), poly(acrylic acid) (PAA), and styrene butadiene styrene copolymer (SBS).

In other features, the battery cell is solid-state. The S separators include a solid electrolyte selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

In other features, a liquid electrolyte including a lithium salt dissolved in at least one organic solvent. The S separators include a layer made of a material selected from a group consisting of polyolefin, cellulose, polyvinylidene fluoride (PVDF), porous polyimide, and a ceramic-coated layer.

A method for manufacturing an anode electrode of a battery cell includes arranging a silicon layer on one side of an anode current collector and depositing a multi-functional solid electrolyte layer in first regions on an opposite side of the silicon layer. The second regions on the opposite side of the silicon layer are not covered by the multi-functional solid electrolyte layer. The method includes depositing a lithium metal layer on the multi-functional solid electrolyte layer in the first regions and on the silicon layer in the second regions.

In other features, the multi-functional solid electrolyte layer is deposited with a thickness in a range from 5 nm to 200 nm. The multi-functional solid electrolyte layer is deposited with a thickness in a range from 20 nm to 60 nm. The first regions comprise 50% to 95% of the one side of the silicon layer. The multi-functional solid electrolyte layer is selected from a group consisting of carbon-incorporated lithium phosphorous oxynitride, lithium phosphorous oxynitride, lithium phosphate, and combinations thereof.

In other features, after a prelithiation period, the multi-functional solid electrolyte layer decomposes to form an artificial solid electrolyte interface including lithium carbonate (Li₂CO₃), lithium nitride (Li₃N), lithium oxide (Li₂O), lithium phosphide (Li₃P), lithium phosphate (Li₃PO₄).

In other features, the multi-functional solid electrolyte layer is selected from a group consisting of carbon-incorporated lithium phosphorous oxynitride. The multi-functional solid electrolyte layer decomposes to form an artificial solid electrolyte interface including lithium carbonate (Li₂CO₃), lithium nitride (Li₃N), lithium oxide (Li₂O), lithium phosphide (Li₃P), lithium phosphate (Li₃PO₄).

In other features, the multi-functional solid electrolyte layer is deposited using magnetron sputtering. The lithium metal layer is deposited using vacuum thermal deposition.

In other features, after a prelithiation period, the silicon layer comprises LixSi where an x is in a range from 0.01 to 3.0. After a prelithiation period, the silicon layer comprises LixSi where an x is in a range from 0.8 to 1.2.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C cathode electrodes, A anode electrodes, and S separators according to the present disclosure;

FIGS. 2A to 2D are side cross sections of illustrating fabrication of one of the A anode electrodes according to the present disclosure;

FIG. 3 is a side cross section of an example of a liquid-based battery cell including one of the A anode electrodes according to the present disclosure;

FIG. 4 is a side cross section of an example of a solid-state battery cell including one of the A anode electrodes according to the present disclosure;

FIGS. 5A and 5B are graphs illustrating an example of initial formation and cycling of a liquid-based battery cell according to the present disclosure; and

FIGS. 6A and 6B are graphs illustrating an example of initial formation and cycling of a solid-state battery cell according to the present disclosure.

In the drawings, reference numbers may be reused to identify similar and/or identical elements.

### DETAILED DESCRIPTION

While the battery cells are described herein in the context of vehicles, the battery cells can be used in other types of mobile applications and/or stationary applications.

Silicon (Si) has emerged as a promising alternative to graphite-based anode electrodes since it is environmentally benign, has reasonable electrochemical potential (~0.3V vs. Li/Li⁺), and a high theoretical capacity (4200 mAh/g for Li_{4.4}Si). However, Si anode electrodes suffer from large volumetric expansion during charging.

The large volume change of the silicon leads to fracture, reformulation of a solid electrolyte interface (SEI), and/or electrode pulverization. The battery cells including the Si anode electrodes also exhibit a loss of active lithium due to the continuous formation of the SEI and an irreversible conversion reaction. As a result, the battery cells including the Si anode electrodes have reduced capacity and/or a shorter cell cycle lifetime.

The present disclosure relates to prelithiated silicon anode electrodes that are manufactured using a spontaneous solid-phase reaction. First regions 57 of a silicon layer of the anode electrode are coated with a thin multi-functional solid electrolyte layer (e.g., 5 nm to 200 nm) while second regions 59 of the silicon layer are not covered. A lithium metal layer is deposited on the first regions 57 of the multi-functional solid electrolyte layer and the second regions 59 (e.g., directly on the silicon layer).

A spontaneous solid-phase reaction occurs between the lithium metal layer and the silicon layer. The solid-phase reaction enables prelithiation of the silicon anode. A robust artificial solid electrolyte interface (SEI) is created due to decomposition of the multi-functional solid electrolyte layer. As a result, the anode electrode has enhanced lithium capacity, improved initial coulombic efficiency, and increased cell cycling capability.

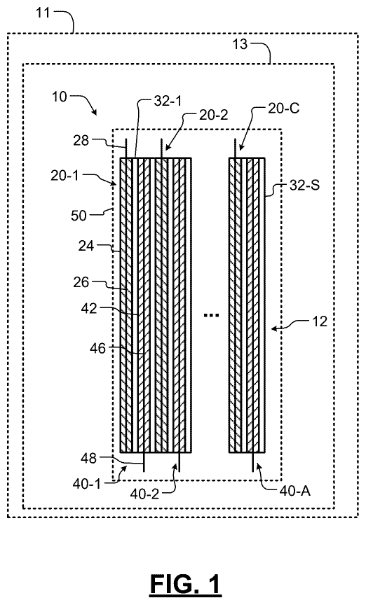

Referring now to FIG. 1, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50. In some examples, the battery cell 10 is liquid-based and a liquid electrolyte is added to the enclosure 50. In other examples, the battery cell is solid-state and solid electrolyte is used.

The C cathode electrodes 20-1, 20-2, . . . , and 20-C include a cathode active material layer 24 arranged on one or both sides of a cathode current collector 26. The A anode electrodes 40-1, 40-2, . . . , and 40-A include an anode active material layer 42 arranged one or both sides of an anode current collector 46.

During charging/discharging, the A anode electrodes 40 and the C cathode electrodes 20 exchange lithium ions. In some examples, the cathode active material layers 24 comprise coatings including one or more active materials, solid electrolyte (for solid-state battery cells), one or more conductive additives, and/or one or more binder materials that are applied to the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

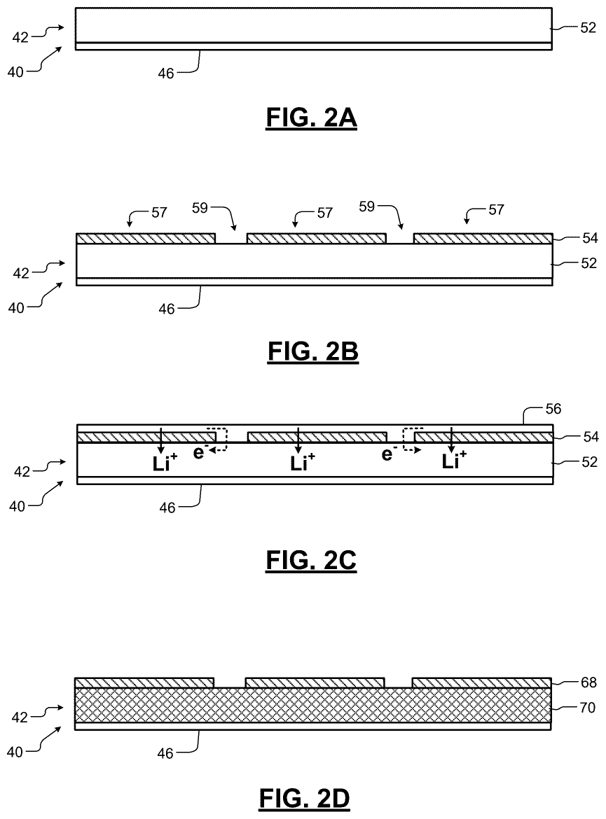

Referring now to FIGS. 2A to 2D, a method for manufacturing one of the A anode electrodes is shown. In FIG. 2A, a silicon layer 52 is formed on one or both sides of the anode current collector 46. In FIG. 2B, first regions 57 of the silicon layer 52 are coated with a thin multi-functional solid electrolyte layer 54 while second regions 59 of the silicon layer 52 are not. In other words, not all of the silicon layer 52 is covered by the multi-functional solid electrolyte layer 54.

In some examples, the multi-functional solid electrolyte layer 54 is selected from a group consisting of carbon-incorporated lithium phosphorous oxynitride (LiCPON (Li_{3.32}C_{0.27}PO_{3.65}N_{0.70})), lithium phosphorous oxynitride (LiPON (Li_{3.3}PO_{3.9}N_{0.17})), lithium phosphate (Li₃PO₄), and combinations thereof. In some examples, the multi-functional solid electrolyte layer 54 is deposited onto the silicon layer 52 using magnetron sputtering, although other methods can be used. In some examples, the multi-functional solid electrolyte layer 54 is deposited in the first regions 57 with a thickness in a range from 5 nm to 200 nm. In some examples, the multi-functional solid electrolyte layer 54 is deposited in the first regions 57 with a thickness in a range from 20 nm to 60 nm. In some examples, the first regions 57 of the silicon layer 52 cover 50% to 95% of a top surface of the silicon layer 52. Second regions 59 cover 5% to 50% of the top surface of the silicon layer 52.

In FIG. 2C, a lithium metal layer 56 is deposited on the multi-functional solid electrolyte layer 54 and the silicon layer 52. In other words, some of the lithium metal layer 56 contacts the multi-functional solid electrolyte layer 54 and some of the lithium metal layer 56 contacts the silicon layer 52. In some examples, the lithium metal layer 56 is deposited using vacuum thermal deposition, although other methods can be used. After a predetermined period, a spontaneous solid-phase reaction occurs between the lithium metal layer 56 and the silicon layer 52. In some examples, the predetermined period is in a range from 1 to 5 days.

The spontaneous solid-phase reaction enables prelithiation of the silicon layer 52 while building up a robust artificial solid electrolyte interface (SEI) due to decomposition of the multi-functional solid electrolyte layer 54. In some examples, the LiCPON decomposes into one or more of lithium carbonate (Li₂CO₃), lithium nitride (Li₃N), lithium oxide (Li₂O), lithium phosphide (Li₃P), and/or lithium phosphate (Li₃PO₄). When lithium phosphorous oxynitride (LiPON (Li_{3.3}PO_{3.9}N_{0.17}) decomposes, the artificial SEI includes lithium nitride (Li₃N), lithium oxide (Li₂O), lithium phosphide (Li₃P). When lithium phosphate (Li₃PO₄) decomposes, the artificial SEI includes Li₂O and Li₃P.

During the solid-phase reaction, lithium ions (Li+) that are stripped from the lithium metal layer 54 are transferred to the silicon layer 52 through the first regions 57 of the multi-functional solid electrolyte layer 54. For example, the ionic conductivity of LiCPON is 3.06×10⁻⁶ S/cm. Electrons (e⁻) required for the spontaneous reaction are conducted through the direct contact between the lithium metal layer 56 and the silicon layer 52 in the second regions 59 of the silicon layer 52 (that are not covered by the multi-functional solid electrolyte layer 54). The lithium ions Li⁺ and electrons e⁻ enable a spontaneous solid-phase reaction between the lithium metal layer 56 and the silicon layer 52 and then effective prelithiation of the silicon layer 52 in the following reaction:

$$S i + x L {i}^{+} + {xe}^{-} ↔ {Li}_{x} S i .$$

The spontaneously formed LixSi compensates for irreversible lithium loss due to the formation of the SEI and enhances lithium capacity. When the multi-functional solid electrolyte layer 54 is LiCPON, it decomposes after contact with the lithium metal layer 56 into Li₂CO₃, Li₃N, Li₂O, Li₃P, and Li₃PO₄. Li₃N, Li₃P, and Li₃PO₄ have higher ionic conductivities and Li₃P has higher electron conductivity. These materials enable an SEI with good ion and electron transport properties. The artificial SEI effectively isolates the contact between the silicon layer 52 and the electrolyte in the first regions 57, inhibits electrolyte decomposition of the separator, and reduces irreversible lithium loss.

In some examples, the anode active material layer includes silicon active material in a range from 30% to 100 wt %, solid electrolyte in a range from 0 wt % to 20 wt %, a conductive additive in a range from 0 wt % to 10 wt %, and a binder in a range from 0 wt % to 10 wt %.

In some examples, the multi-functional solid electrolyte layer 54 is deposited onto the silicon layer 52 using magnetron sputtering. In some examples, the multi-functional solid electrolyte layer 54 is deposited in the first regions 57 with a thickness in a range from 5 nm to 200 nm. In some examples, the multi-functional solid electrolyte layer 54 is deposited in the first regions 57 with a thickness in a range from 20 nm to 60 nm. In some examples, the multi-functional solid electrolyte layer 54 covers in a range from 50 to 95% of the silicon layer 52. In some examples, the multi-functional solid electrolyte layer 54 includes carbon-incorporated lithium phosphorous oxynitride (Li_{3.32}C_{0.27}PO_{3.65}N_{0.70}) (LICPON), lithium phosphorous oxynitride (Li_{3.3}PO_{3.9}N_{0.17}) (LiPON)), lithium phosphate (Li₃PO₄), and combinations thereof.

In some examples, the lithium metal layer 56 is deposited on the multi-functional solid electrolyte layer 54 and the silicon layer 52 using vacuum thermal deposition. In some examples, the lithium metal layer 56 has a target thickness in a range from 1 to 20 μm. In some examples, the lithium metal layer 56 has a target thickness in a range from 2 to 6 μm.

In some examples, after spontaneous solid-phase prelithiation, the formed artificial SEI of the anode electrode includes Li₂CO₃ in a range from 8 to 16 wt %, Li₃N in a range from 12 to 18 wt %, Li₂O in a range from 20 to 30 wt %, Li₃P in a range from 18 to 26 wt %, and Li₃PO₄ in a range from 18 to 26 wt %. In some examples, after spontaneous solid-phase prelithiation, the LixSi anode electrode has an “x” value in a range from 0.01 to 3.0. After spontaneous solid-phase prelithiation, the LixSi anode electrode has an “x” value in a range from 0.8 to 1.2.

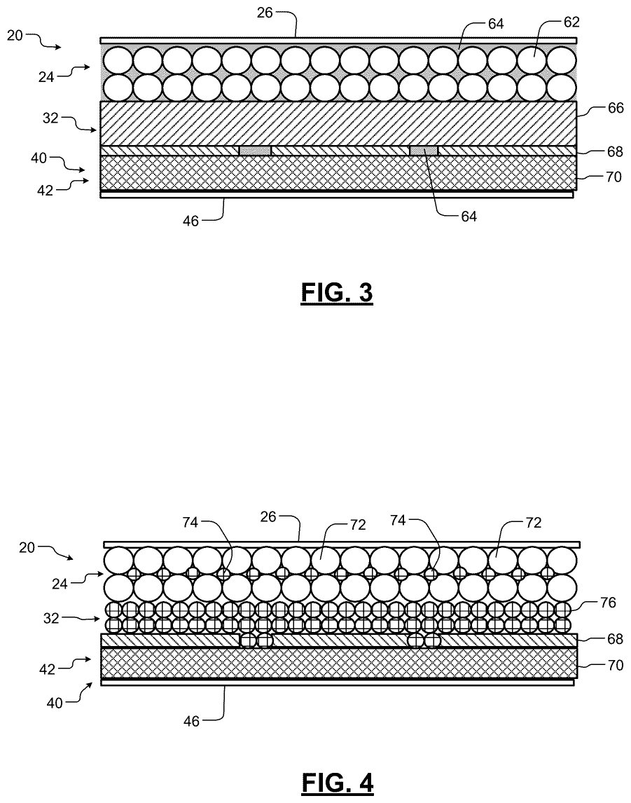

Referring now to FIG. 3, the prelithiated silicon anode electrode described above can be used in a liquid-electrolyte-based lithium ion battery cell to enhance delivered lithium capacity and/or cell cyclability. In this example, the C cathode electrodes include cathode active material 62 (e.g., such as LCO) and a liquid electrolyte 64 (such as 1.2 M LiPF₆ in carbonate). A separator 32 includes a polymeric separator such as polypropylene (PP)/polyethylene (PE). The anode electrode is described above.

More generally, the liquid electrolyte includes a lithium salt dissolved in an organic solvent or a mixture of organic solvents. In some examples, the lithium salt is selected from a group consisting of lithium hexafluorophosphate, lithium perchlorate, lithium tetrafluoroborate, lithium bis(trifluoromethane) sulfonylimide, and combinations thereof. In some examples, the solvent is selected from a group consisting of carbonates, esters, lactones, chain structure ethers, cyclic ethers, and combinations thereof.

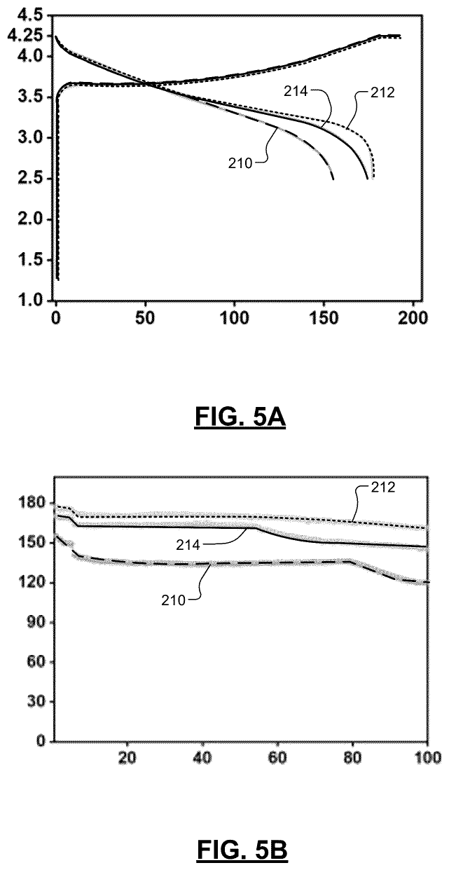

Referring now to FIG. 4, the prelithiated silicon anode electrode described above can be used in solid-state battery cells to enhance delivered lithium capacity and/or cell cyclability. In this example, the C cathode electrodes include cathode active material 72 (e.g., such as NMC721) and a solid electrolyte 74 (such as Li₆PS₅Cl). A separator 32 includes a solid electrolyte (such as Li₆PS₅Cl). The anode electrode is described above.

In some examples, the cathode active material layer includes cathode active material in a range from 30 wt % to 98 wt %, a solid electrolyte in a range from 0 to 30 wt %, a carbon additive in a range from 0 wt % to 20 wt %, and a binder in a range from 0 wt % to 20 wt %.

In some examples, the cathode active material is selected from a group consisting of a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In some examples, the cathode active material includes sulfur or lithium sulfide (Li₂S). In some examples, the cathode active material is coated by a coating layer including lithium niobate (LiNbO₃) and/or lithium phosphate (Li₃PO₄).

In some examples, the conductive additive includes carbon black, graphite, graphene, graphene oxide, Super P, acetylene black, carbon nanofibers, carbon nanotubes and other electronically conductive additives.

In some examples, the binder comprises one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-cohexafluoropropylene) (PVDF-HFP), polyethylene oxide (PEO), polyacrylonitrile (PAN), poly(acrylic acid) (PAA), styrene butadiene styrene copolymer (SBS), and so on.

In some examples, the solid electrolyte is selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂Ss system, Li₂S—P₂S₃ system, and Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system, (Li_{3.25}Ge_{0.25}P_{0.75}S₄ and Li₁₀GeP₂S₁₂), Li₂S—P₂S₅—LiX system (where X=F, Cl, Br, I), (Li₃PS₅Br, Li₆PS₅Cl, L₇P₂S₈I and Li₄PS₄I), Li₂S—As₂S₅—SnS₂ system, (Li_{3.833}Sn_{0.833}As_{0.166}S₄) system, Li₂S—P₂S₅—Al₂S₃ system, Li₂S—LiX—SiS₂ system (where X=F, Cl, Br, I), 0.4LiI-0.6Li₄SnS₄, and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of the halide-based sulfide electrolyte include Li₃YCl₆, Li₃InCl₆, Li₃YBr₆, LiI, Li₂CdC₁₄, Li₂MgC₁₄, Li₂Cd₁₄, Li₂Zn₁₄, and Li₃OCl. Examples of the hydride-based sulfide electrolyte include LiBH₄, LiBH₄—LiX (X=Cl, Br, or I), LiNH₂, Li₂NH, LiBH₄—LiNH₂, and Li₃AlH₆.

Examples of oxide-based solid electrolyte include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃, LISICON type (e.g., Li₂₊₂ₓZn₁₋ₓGeO₄).

Examples of metal-doped or aliovalent-substituted oxide solid electrolyte include Al, Nb or Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂. Examples of nitride-based solid electrolyte include Li₃N, Li₇PN₄, LiSi₂N₃. Examples of borate-based solid electrolyte include Li₂B₄O₇, Li₂O—B₂O₃—P₂O₅.

In some examples, the separator includes a solid electrolyte membrane including solid electrolyte in a range from 20 wt % to 100 wt %, a filler in a range from 0 wt % to 30 wt %, and a binder in a range from 0 wt % to 20 wt %. In some examples, the solid electrolyte is selected from the examples listed above.

In some examples, the filler includes at least one material selected from the group consisting of oxide particles, a polymer framework, a lithium salt, and combinations thereof. In some examples, the oxide particles are selected from a group consisting of silicon oxide (SiO₂), aluminum oxide (Al₂O₃), titanium oxide (TiO₂), and zirconium oxide (ZrO₂). In some examples, the polymer framework includes polypropylene (PP) or polyethylene (PE).

In some examples, the binder of the solid electrolyte membrane includes polyvinylidene fluoride) (PVDF), polyvinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), Poly(ethylene oxide) (PEO), polyvinylpyrrolidone (PVP), polyvinyl alcohol), poly(acrylic acid) (PAA), and so on. In some examples, the solid electrolyte membrane has a thickness in a range from 5 μm to 200 μm.

In some examples, the separator layer in FIG. 2 has a porosity in a range from 5% to 100% (e.g., 90%). The liquid electrolyte wets the porosity of the separator layer. In some examples, the separator layer is made of a material selected from a group consisting of polyolefin, cellulose, polyvinylidene fluoride (PVDF), porous polyimide, a ceramic-coated layer, and a high temperature stable material.

In some examples, the polyolefin-based separator is selected from a group consisting of polyacetylene: polypropylene (PP), polyethylene (PE), dual layer type: PP-PE, three layer type (PP-PE-PP). In some examples, the ceramic-coated separator includes a silicon oxide (SiO₂)-coated PE layer.

In some examples, the high-temp-stable material is selected from a group consisting of polyimide (PI) nanofiber-based nonwovens, nano-sized Al₂O₃ and poly(lithium 4-styrene sulfonate)-coated polyethylene membrane, SiO₂ coated polyethylene (PE) separator, a cepolyimide-coated polyethylene separator, a polyetherimides (PEI) (bisphenol-aceton diphthalic anhydride (BPADA) and para-phenylenediamine) separator, an expanded polytetrafluoroethylene reinforced polyvinylidenefluoride-hexafluoropropylene separator, a sandwich-structured PVdF/PMIA/PVdF nanofibrous separators, etc.

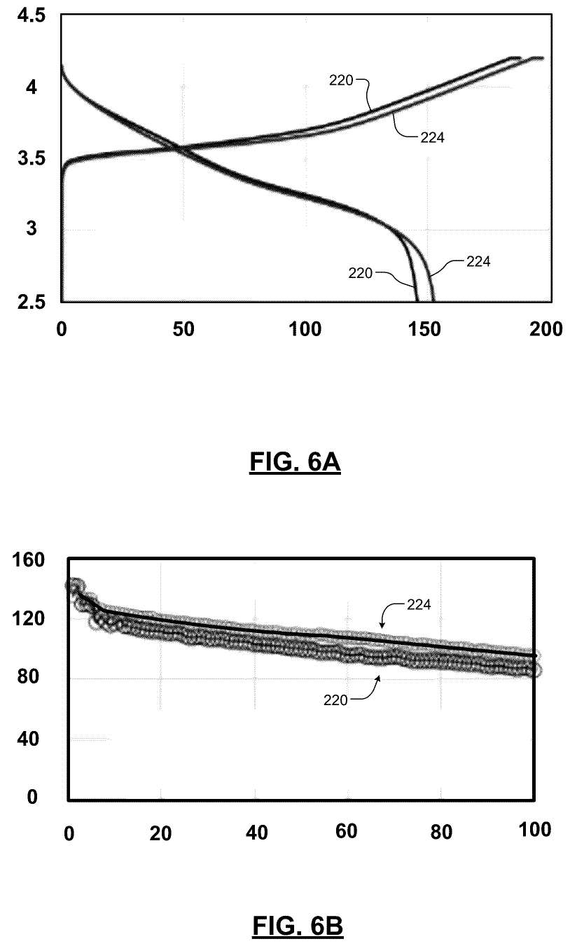

Referring now to FIGS. 5A and 5B, initial formation and cycling performance of the liquid-based battery cell in FIG. 3 is shown. Initial formation for a first battery cell including an anode electrode with a silicon layer is shown at 210. The first battery cell produced a charge capacity of 192 mAh/g, a discharge capacity of 155 mAh/g, and a coulombic efficiency of 81%. A second battery cell includes an anode electrode with a silicon layer, a multi-functional solid electrolyte layer (50 nm LiCPON), and a lithium layer (6 μm lithium metal) at 212. The second battery cell produced a charge capacity of 192 mAh/g, a discharge capacity of 177 mAh/g, and a coulombic efficiency of 92%. A third battery cell includes an anode electrode with a silicon layer and a lithium metal layer (e.g., 6 μm lithium) at 214. The third battery cell produced a charge capacity of 190 mAh/g, a discharge capacity of 175 mAh/g, and a coulombic efficiency of 92%. As can be appreciated, the prelithiated Si film obtained by spontaneous solid-phase reaction significantly enhanced the delivered lithium capacity, initial coulombic efficiency, and cell cycling.

Referring now to FIGS. 6A and 6B, initial formation and cycling performance of the solid-state battery cell in FIG. 4 is shown. Initial formation for a first battery cell including an anode electrode with a silicon layer is shown at 220. The first battery cell produced a charge capacity of 190 mAh/g, a discharge capacity of 145 mAh/g, and a coulombic efficiency of 76%. A second battery cell including an anode electrode with a silicon layer, a multi-functional solid electrolyte layer (50 nm LiCPON), and a lithium layer (6 μm lithium) at 224. The second battery cell produced a charge capacity of 191 mAh/g, a discharge capacity of 153 mAh/g, and a coulombic efficiency of 80%. The prelithiated Si film obtained by spontaneous solid-phase reaction significantly enhances the delivered lithium capacity, initial coulombic efficiency and cell cycling.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes including a cathode active material layer arranged on one or both sides of a cathode current collector;
A anode electrodes; and
S separators arranged between adjacent ones of the C cathode electrodes and the A anode electrodes, where C, S and A are integers greater than one,
wherein each of the A anode electrodes includes:
an anode current collector;
a lithium silicide layer arranged on the anode current collector; and
an artificial solid electrolyte interface arranged in first regions on one side of the lithium silicide layer and not in second regions on the one side of the lithium silicide layer.

2. The battery cell of claim 1, wherein the artificial solid electrolyte interface includes one or more materials selected from a group consisting of lithium carbonate (Li₂CO₃), lithium nitride (Li₃N), lithium oxide (Li₂O), lithium phosphide (Li₃P), lithium phosphate (Li₃PO₄), and combinations thereof.

3. The battery cell of claim 2, wherein the first regions comprise 50% to 95% of the one side of the lithium silicide layer.

4. The battery cell of claim 1, wherein the artificial solid electrolyte interface includes lithium carbonate (Li₂CO₃), lithium nitride (Li₃N), lithium oxide (Li₂O), lithium phosphide (Li₃P), and lithium phosphate (Li₃PO₄).

5. The battery cell of claim 1, wherein the lithium silicide layer comprises LixSi where an x is in a range from 0.01 to 3.0.

6. The battery cell of claim 1, wherein the cathode active material layer includes a cathode active material selected from a group consisting of a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by at least one of LiMeSO₄F or LiMePO₄F, sulfur, lithium sulfide, and combinations thereof, where Me is a transition metal.

7. The battery cell of claim 6, wherein the cathode active material includes a coating layer including LiNbO₃ and/or Li₃PO₄.

8. The battery cell of claim 6, wherein:
the cathode active material layer further includes a solid electrolyte selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof, and
the cathode active material layer further includes a binder selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-cohexafluoropropylene) (PVDF-HFP), polyethylene oxide (PEO), polyacrylonitrile (PAN), poly(acrylic acid) (PAA), and styrene butadiene styrene copolymer (SBS).

9. The battery cell of claim 1, wherein:
the battery cell is solid-state, and
the S separators include a solid electrolyte selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

10. The battery cell of claim 1, further comprising:
a liquid electrolyte including a lithium salt dissolved in at least one organic solvent,
wherein the S separators include a layer made of a material selected from a group consisting of polyolefin, cellulose, polyvinylidene fluoride (PVDF), porous polyimide, and a ceramic-coated layer.

11. A method for manufacturing an anode electrode of a battery cell, comprising:
arranging a silicon layer on one side of an anode current collector;
depositing a multi-functional solid electrolyte layer in first regions on an opposite side of the silicon layer,
wherein second regions on the opposite side of the silicon layer are not covered by the multi-functional solid electrolyte layer; and
depositing a lithium metal layer on the multi-functional solid electrolyte layer in the first regions and on the silicon layer in the second regions.

12. The method of claim 11, wherein the multi-functional solid electrolyte layer is deposited with a thickness in a range from 5 nm to 200 nm.

13. The method of claim 11, wherein the multi-functional solid electrolyte layer is deposited with a thickness in a range from 20 nm to 60 nm.

14. The method of claim 11, wherein the first regions comprise 50% to 95% of the one side of the silicon layer.

15. The method of claim 11, wherein the multi-functional solid electrolyte layer is selected from a group consisting of carbon-incorporated lithium phosphorous oxynitride, lithium phosphorous oxynitride, lithium phosphate, and combinations thereof.

16. The method of claim 15, wherein, after a prelithiation period, the multi-functional solid electrolyte layer decomposes to form an artificial solid electrolyte interface including lithium carbonate (Li₂CO₃), lithium nitride (Li₃N), lithium oxide (Li₂O), lithium phosphide (Li₃P), and/or lithium phosphate (Li₃PO₄).

17. The method of claim 11, wherein:
the multi-functional solid electrolyte layer is selected from a group consisting of carbon-incorporated lithium phosphorous oxynitride, and
the multi-functional solid electrolyte layer decomposes to form an artificial solid electrolyte interface including lithium carbonate (Li₂CO₃), lithium nitride (Li₃N), lithium oxide (Li₂O), lithium phosphide (Li₃P), and lithium phosphate (Li₃PO₄).

18. The method of claim 11, wherein:
the multi-functional solid electrolyte layer is deposited using magnetron sputtering, and
the lithium metal layer is deposited using vacuum thermal deposition.

19. The method of claim 11, wherein, after a prelithiation period, the silicon layer comprises LixSi where an x is in a range from 0.01 to 3.0.

20. The method of claim 11, wherein, after a prelithiation period, the silicon layer comprises LixSi where an x is in a range from 0.8 to 1.2.
